(19) United States
(12) Patent Application Publication
(10) Pub. No.: US 2012/0127530 A1
(43) Pub. Date: May 24, 2012

(54) IMAGE PROCESSING APPARATUS AND CONTROL METHOD OF DATA WRITING

(75) Inventor: Yutaka HOSONO, Kawasaki-shi (JP)

(73) Assignee: Konica Minolta Business Technologies, Inc., Chiyoda-ku (JP)

(21) Appl. No.: 13/294,225

(22) Filed: Nov. 11, 2011

(30) Foreign Application Priority Data
Nov. 19, 2010 (JP) 2010-258669

(51) Int. Cl. G06K 15/02

(52) U.S. Cl. 358/1.16

(57) ABSTRACT

An image processing apparatus for executing an image processing of print data and instructing a printing to a printing apparatus having a consumable supply, comprising:
a control section which is configured to monitor an exchange operation of the consumable supply and to execute a data rewriting of a nonvolatile memory by using a volatile memory to be used for the image processing.

### CROSS REFERENCE TO RELATED APPLICATION

The present application is based on Japanese Patent Application No. 2010-258669 filed with Japanese Patent Office on Nov. 19, 2010, the entire content of which is hereby incorporated by reference.

### BACKGROUND OF THE INVENTION

1. Technical Field

The present invention relates to an image processing apparatus and a control method of data writing, and particularly relates to an image processing apparatus provided with a consumable supply and a control method of data writing to a nonvolatile memory in said image forming apparatus.

2. Description of Prior Art

Apparatuses for executing various controls are provided with programs to operate the apparatuses and nonvolatile memories to store data for setting information of the apparatuses. The nonvolatile memory is capable of storing data even after putting off the power. However in recent years, miniaturization of the nonvolatile memory has progressed in accordance with development of its manufacturing process, and due to the miniaturization, the retention period of the data has become shorter than the life of the apparatus, which makes it necessary of rewriting in order for maintaining the data.

As for the technology relating to such rewriting of data, JP 2002-318729A (Patent Document 1) for example, discloses a configuration where with respect to a nonvolatile semiconductor memory apparatus, which is structured with a plurality of erasable blocks and is erasable of data by the block unit, the erasable block is divided into logically smaller memory area units, a file is managed by the use of status information of said erasable block and memory area unit, and further, in the file system to execute restructuring operation of the block to release the invalid memory area unit included in the erasable block, provided are a restructured date memory means to store the date of restructuring the block by each of the erasable block, and a restructuring control means that preferentially executes the restructuring process to the block having elapsed a prescribed time period from the date memorized in the restructured date memory means.

Further, JP 2000-011670A (Patent Document 2) discloses an apparatus which has a timer for counting a elapsed time period since executing a writing operation to a nonvolatile memory in an apparatus having the nonvolatile memory, and a refresh circuit for writing again to the nonvolatile memory when the elapsed time counted by the timer exceeds a prescribed period.

### Problems to be Solved by the Invention

Rewriting of data in the nonvolatile memory is usually executed by temporarily developing the data stored in the nonvolatile memory on a volatile memory, and writing back onto the nonvolatile memory. However, since preparing a volatile memory exclusively for rewriting the data causes cost-up, the volatile memory to be used for the process of the apparatus is usually used also for rewriting. Therefore, if the data rewriting to the nonvolatile memory is executed while the apparatus is conducting the process, since the volatile memory is used also for rewriting the data, the process being conducted will be caused a problem.

In cases where the apparatus provided with the nonvolatile memory requiring the data rewriting is a computer apparatus, since a serious problem will not be caused even if the time required for starting up the apparatus becomes longer in some degree, it is possible to execute the data rewriting on the nonvolatile memory at the staring up time. Further, even in cases where the apparatus is used in the state of always-power-on, since processes to be executed in the night time is usually limited, it is possible to execute the data rewriting on the nonvolatile memory in the night time.

However, with respect to printing apparatuses such as a printer or an MFP (Multi Function Peripheral), since it is required to shorten the time for starting up the apparatus (for example, the time from power-off state to activation, or the recovery time from sleep state to stand-by state), it is not preferable to execute the data rewriting on the nonvolatile memory at the staring up time. Further, with respect to the printing apparatus being used by many users, it is not preferable to execute the data rewriting on the nonvolatile memory even in the night time, since a job may be transmitted at any time. Therefore, in cases of the printing apparatus, there has been a problem that executing the data rewriting on the nonvolatile memory without causing a trouble to the process being executed is difficult.

In view of the abovementioned problems, a main objective of the present invention is to provide an image processing apparatus and a control method of data rewriting that can effectively execute the data rewriting of the nonvolatile memory without causing a trouble to the process being executed.

### SUMMARY

In order to achieve at least one of the abovementioned problems, an apparatus reflecting one aspect of the present invention is an image processing apparatus for executing an image processing of print data and instructing a printing to a printing apparatus having a consumable supply, the apparatus including: a control section which is configured to monitor an exchange operation of the consumable supply and to execute a data rewriting of a nonvolatile memory by using a volatile memory to be used for the image processing.

A method reflecting another aspect of the present invention is a control method of data writing in a printing system having a printing apparatus provided with a consumable supply, and an image processing apparatus for executing an image processing of print data and instructing a printing to the printing apparatus, the control method of data writing for the image processing apparatus including: a first step of monitoring an exchange operation of the consumable supply of the printing apparatus; and a second step of executing a data rewriting of a nonvolatile memory by using a volatile memory to be used for the image processing.

### BRIEF DESCRIPTION OF THE DRAWINGS

These and other objects, advantages and features of the invention will become apparent from the following description thereof taken in conjunction with the accompanying drawings in which:

FIG. 1 is a diagram showing a data flow at the time of usual print process in a printing system relating to an embodiment of the present invention;

FIG. 2 is a diagram showing a data flow at the time of data rewriting of the nonvolatile memory in a printing system relating to an embodiment of the present invention;

FIG. 3 is a flow chart diagram showing operations of a controller relating to an embodiment of the present invention;

FIG. 4 is a diagram showing an example of a screen to be displayed in an engine relating to an embodiment of the present invention;

FIG. 5 is a flow chart diagram showing the other operations of a controller relating to an embodiment of the present invention;

FIG. 6 is a flow chart diagram showing the other operations of a controller relating to an embodiment of the present invention; and

FIG. 7 is a diagram showing a transition example of screens to be displayed in an engine relating to an embodiment of the present invention.

### DETAILED DESCRIPTION OF THE PREFERRED EMBODIMENT

As describe in the description of prior art, the nonvolatile memory to store the data such as a program for operating the apparatus and setting information is required of periodical data rewriting, since there is a warranty period for data retention. Further, the data rewriting is executed by developing the data stored in the nonvolatile memory onto a volatile memory and writing back to the nonvolatile memory. As for this volatile memory, due to cost aspect, a volatile memory to be used for the process of the apparatus is used also for rewriting.

Therefore, if the data rewriting is executed while the apparatus is executing a process, accesses to the volatile memory conflict with each other to cause a problem to the process being executed. Thus, the data rewriting of the nonvolatile memory is preferably executed while the process is not being executed. However, for the apparatus such as the image processing apparatus, which is required of quick start-up, and possibly executes a job even in the night time, executing the data rewriting in what timing is important.

Meanwhile, various consumable supplies are used in the image processing apparatus, and processes such as printing cannot be executed at the time of exchanging the consumable supplies, therefore, even executing the data rewriting at the time of exchanging the consumable supplies, the process such as printing would not be caused a problem.

In an embodiment of the present invention, in view of the characteristics of this type of image processing apparatus, controlled is such that the data rewriting of the nonvolatile memory is prohibited during operation or image formation of the image processing apparatus, and the data rewriting of the nonvolatile memory is executed in the state where the image processing apparatus cannot operate or the image formation cannot be done, for example during the exchange time of the consumable supplies such as a toner bottle and a print unit.

Due to this, the other process will not be interrupted by the data rewriting of the nonvolatile memory, and the data rewriting can be effectively executed.

### [Example]

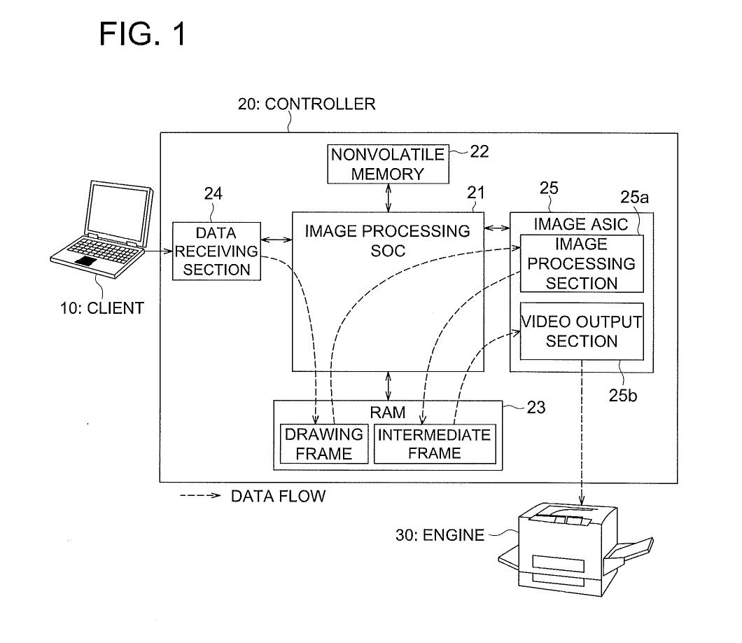

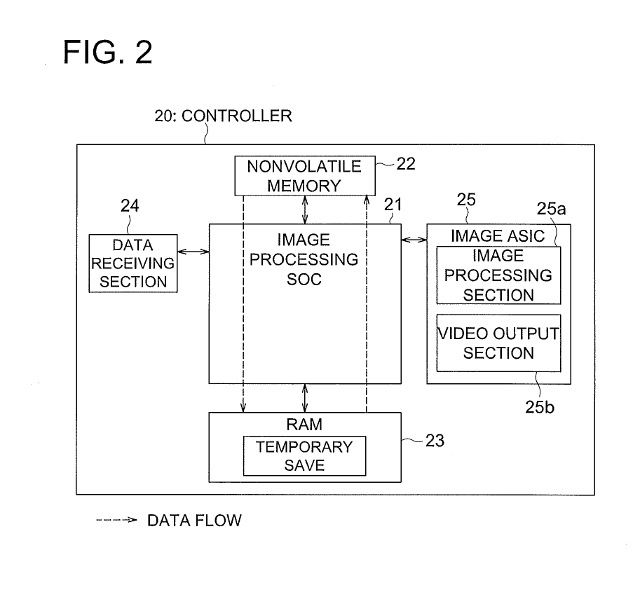

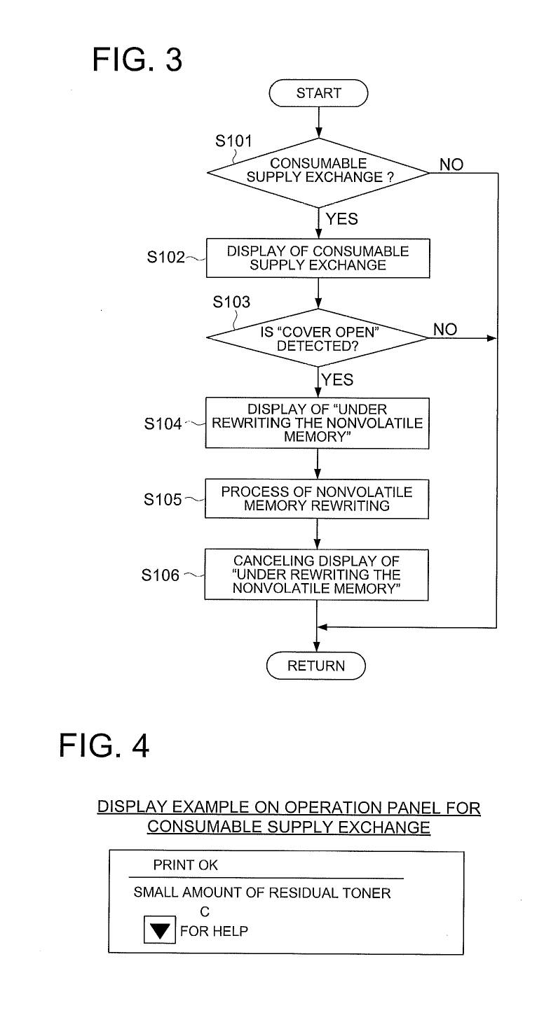

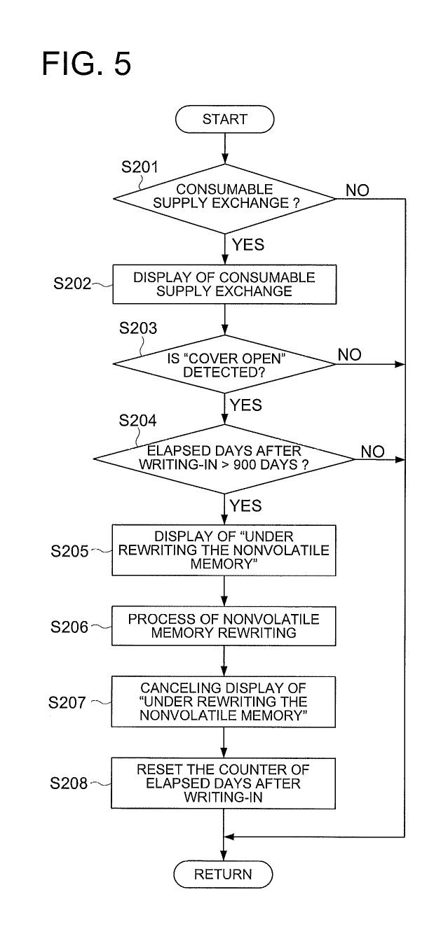

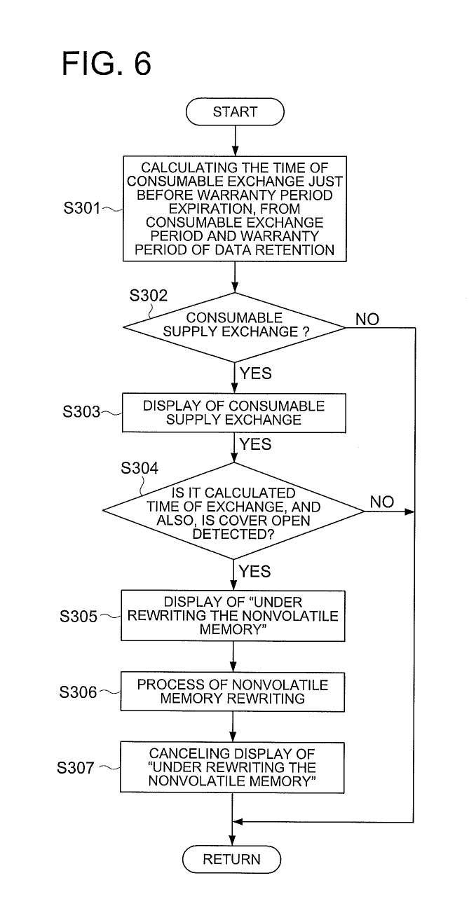

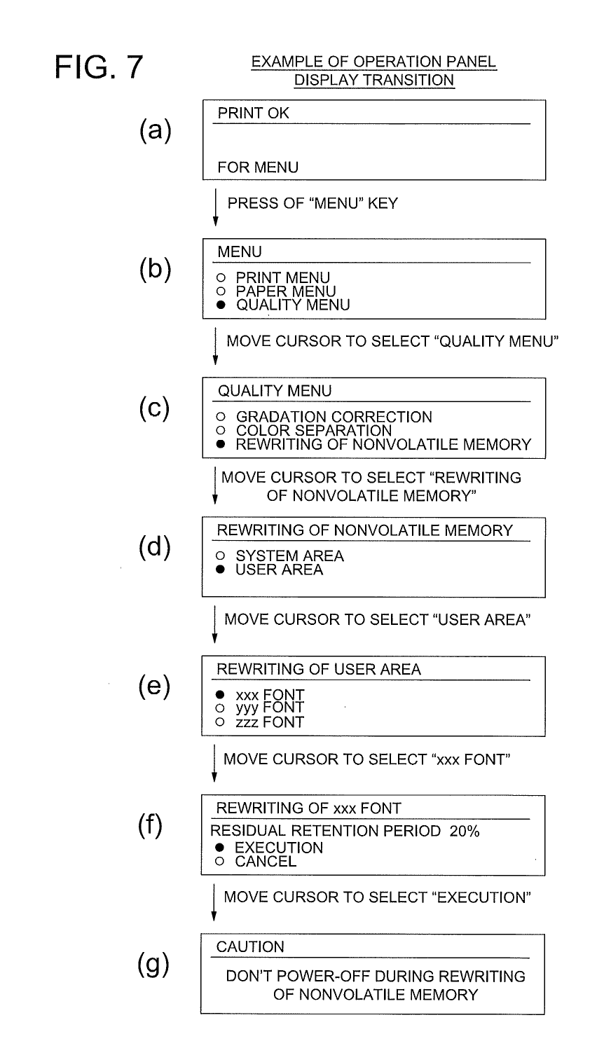

To explain the above described embodiment of the present invention more in detail, the image forming apparatus and the control method of data writing relating to an embodiment of the present invention will be described referring to FIGS. 1-7. FIG. 1 is a diagram showing a data flow at the time of usual print process in a printing system of the present embodiment; FIG. 2 is a diagram showing a data flow at the time of data rewriting of the nonvolatile memory; FIG. 3 is a flow chart diagram showing operations of the controller of the present embodiment; and FIG. 4 is a diagram showing an example of a screen to be displayed in an engine relating to an embodiment of the present invention. Further, FIGS. 5 and 6 are flow chart diagrams showing the other operations of a controller of the present embodiment; and FIG. 7 is a diagram showing a transition example of screens to be displayed in an engine.

As shown in FIG. 1, the printing system of the present embodiment includes client 10 to instruct the printing, and controller 20 and engine 30 to execute a process according to the instruction, these being connected by a communication network such as a LAN (Local Area Network) and WAN (Wide Area Network). Although in FIG. 1, controller 20 and engine 30 are shown as separate apparatuses, the configuration where controller 20 is included in engine 30 is also possible. Each apparatus will be specifically described below.

### [Client]

Client 10 is a computer apparatus such as a personal computer, and provided with a control section, an OS (operating System), an application, a printer driver, a communication I/F section, memory section, display section, operation section, and the like.

Control section is configured with a CPU (Central Processing Unit), a ROM (Read Only Memory), a RAM (Random Access Memory), and the like, and controls the overall operation of client 10. OS is such as Windows™, Mackintosh™, or the like that enables the operation of the application in client 10. The application is software to create a document data and the like. The printer driver converts the document data created with the application into print data of the language readable by controller 20 (PCL: Printer Control Language or PDL: Page Description Language). The communication I/F section is configured of MC (Network Interface Card) and the like, and connects client 10 to the communication network. The memory section is configured of a memory or a HDD (Hard Disc Drive) and the like, to memorize the print data, etc. The display section is configured of LCD (Liquid Crystal Display) and the like, to display a document creation screen, print screen and the like. The operation section is configured of a mouse, keyboard and the like to enable the operation such as a print instruction.

### [Controller]

Controller 20 is an image processing apparatus which controls engine 30 based on the instruction of client 10, and is provided with image processing SOC (System-on-a-Chip) 21, nonvolatile memory 22, volatile memory (RAM 23), data receiving section 24, image ASIC (Application Specific Integrated Circuit) 25 and the like.

Image processing SOC 21 functions as a control section to control the total operation of controller 20, analyzes the print data obtained from client 10, and executes the process such as a rasterizing process to form a drawing frame, a control of data transfer to nonvolatile memory 22 and RAM 23 and the like. Image processing SOC 21 executes the control of monitoring the status of engine 30 to detect the exchange operation of consumable supplies, determining whether to execute the data rewriting or not based on the warranty period of data retention in nonvolatile memory 22, calculating the exchange timing of the consumable supplies, when the data rewriting is to be executed, based on the warranty period of data retention in nonvolatile memory 22 and exchange period of the consumable supplies, executing the data rewriting of nonvolatile memory 22 at the time of consumable exchange, and displaying the screen relating to the data rewriting on the operation panel section of engine 30.

Nonvolatile memory 22 stores, for example, information necessary for converting the print data to the data being able to be outputted by engine 30, warranty period information of data retention in nonvolatile memory 22, exchange period information of the consumable supplies, and the like. Volatile memory (RAM 23) temporarily stores a drawing frame, an intermediate frame, data stored in nonvolatile memory 22, elapsed time information after exchanging the consumable supplies, and the like. Data receiving section 24 is configured of NIC and the like, and receives the print data from client 10. Image ASIC 25 is provided with image processing section 25a and video output section 25b. Image processing section 25a processes the drawing frame to form the intermediate frame, and video output section 25b converts the intermediate frame to video signals and outputs to engine 30.

### [Engine]

Engine 30 is a printing apparatus to execute printing based on the instruction of controller 20, and is configured with a control section, a communication I/F section, an operation panel section, a printing section and the like.

The control section of engine 30 is configured with a CPU, memories such as a ROM and a RAM, and controls the total operation of engine 30. The communication I/F section is configured with NIC and the like, and receives the video signals from controller 20. The operation panel section is configured with a pressure sensitive operation section (touch panel) where transparent electrodes are arranged in lattice pattern on a display section, and enables to display screens relating to the data rewriting and to execute the setting operation of the movement of engine 30. The printing section 30 is provided with a photosensitive material, a charging device, an exposing device, a developing device, a transfer device, a fixing device and the like, and executes the printing based on the video signals received by the communication I/F section. In this printing section, consumable supplies such as a toner bottle and a print unit are included.

The printing system of the present embodiment is not restricted to the abovementioned configuration, but any configuration which can execute the printing process will be applicable. For example, although the present embodiment is configured such that the printing process is executed based on the print data transmitted from client 10, the printing process may be executed based on the data stored in controller 20 or a server, in which case client 10 can be omitted. Further, although in the present embodiment, the data rewriting of nonvolatile memory 22 in controller 20 is executed at the time of consumable exchange of engine 30, in cases where consumable supply is provided in controller 20, the data rewriting of nonvolatile memory 22 may be executed at the time of exchanging the consumable supply provided in controller 20. Further, although in the present embodiment, the configuration is such that the screen relating to the data rewriting is displayed on the operation panel section of engine 30, in cases where a display section is provided at controller 20, the screen relating to the data rewriting may be displayed on the display section provided at controller 20.

Data flow in the printing system of the abovementioned configuration is described below.

In the case of usual printing process, as shown in FIG. 1, image processing SOC 21 processes the print data received by data receiving section 24, such as LAN or USB (Universal Serial Bus) port, from client 10 to create a drawing frame, and saves the created drawing frame in the volatile memory (RAM 23).

The drawing frame is DMA (Direct Memory Access) transferred to image processing section 25a of image ASIC 25. Image processing section 25a processes the transferred drawing frame to form an intermediate frame and DMA transfers to RAM 23, and RAM 23 stores the intermediate frame. The intermediate frame is DMA transferred to video output section 25b of image ASIC 25, and video output section 25b converts the intermediate frame into video signals to output the video signals on engine 30 for executing a printing.

While, in the case of data rewriting in nonvolatile memory 22, as shown in FIG. 2, image processing SOC 21 temporarily stores the data of nonvolatile memory 22 in RAM 23, and writes back the data into nonvolatile memory 22. Wherein, since a control program compressed and stored in nonvolatile memory 22 is already developed on RAM 23 at the time of starting up the apparatus, data already exist in RAM 23, in such case, the data is compressed and rewritten.

As described above, in RAM 23 of controller 20, at the time of usual printing process, writing-in/reading-out of the drawing frame and the intermediate frame are executed, and at the time of data rewriting of nonvolatile memory 22, writing-in/reading-out of the data in nonvolatile memory are executed. Therefore, if the data rewriting is executed at the time of printing process, the bus from image processing SOC 21 to RAM 23 is used also for the data rewriting, thus, the usage of the bus for printing process is broken off while the data rewriting process uses the bus, which causes a problem to the printing process and impedes user's convenience.

Therefore, according to the present embodiment, image processing SOC controls to prohibit the data rewriting of nonvolatile memory 23 while the printing process is executed, and to execute the data rewriting of nonvolatile memory 22 along with the timing when the printing process cannot be executed for a prescribed time period, for example during the time of exchanging the consumable supplies such as a toner bottle and a print unit. Herewith, delay of the printing process due to the data rewriting of nonvolatile memory 22 is prevented and user's convenience is improved.

Operations of controller 20 of the present embodiment will be described referring to the flow chart of FIG. 3.

Firstly, controller 20 determines if exchange of consumable supply is required by monitoring the status (for example, remaining amount of toner, or operation status of a print unit) of engine 33 (S101). In cases where the exchange of consumable supply is determined to be necessary, controller 20 allows operation panel section of engine 30 to display a screen urging the user to exchange the consumable supply as shown in FIG. 4 for example (S102). Wherein the consumable supply of the present embodiment is not restricted to the toner bottle or the print unit, but any parts is applicable which requires a break of a job process during replacement, repairing or adjustment of the parts.

Next, controller 20 monitors the operation for exchanging the consumable supply (for example, operation of opening the cover of engine 30) (S103), and when detecting the operation, allows operation panel section of engine 30 to display a screen for notifying the user that the data rewriting of nonvolatile memory 22 is under execution (S104). Since if the power is put off during the data rewriting of nonvolatile memory 22 contents of the data may possibly be destroyed, this step of display is done for calling for attention.

Next, controller 20 executes the process of data rewriting of nonvolatile memory 22 (S105). Specifically, image processing SOC 21 temporarily stores the data of nonvolatile memory 22 into RAM 23, and writes back the data into nonvolatile memory 22. In this case, the unit of rewriting, namely the unit for managing the rewriting time, may be set as the all data of nonvolatile memory 22, as each memory in cases where a plurality of nonvolatile memory 22 are provided, as a unit of file stored in nonvolatile memory 22, or as a unit of erasing block defined by physical conditions in case of flash memory which being a type of nonvolatile memory 22. For example, in cases where the time required for exchanging the consumable supply is short and the rewriting of all data in nonvolatile memory 22 is judged to be difficult, it is possible to execute the data rewriting by the abovementioned file unit or block unit in accordance with the time required for exchanging the consumable supply.

Then after completing the data rewriting, by canceling the display, displayed at S104, of under rewriting the data of nonvolatile memory on the operation panel of engine 30 (S106) and a series of the process terminates.

As described above, since controller 20 controls to execute the data rewriting of nonvolatile memory at the time of exchanging the consumable supply of engine 30, delay of printing process due to the data rewriting is prevented from occurring, which improves the user's convenience.

In the above flow, since the data rewriting of nonvolatile memory 22 is executed in accordance with the exchange timing of the consumable supply, the data rewriting may be executed more frequently than necessary depending on exchanging time interval of the consumable supply. For example, in a case where warranty period of data retention of nonvolatile memory 22 is 3 years and the machine life of apparatus main body is 10 years, although the data rewriting is required at least 3 times during the life, since the exchange of consumable supply is usually conducted several times per year, the data rewriting is to be executed some dozen times within the machine life.

So, in order to suppress the excessive data rewriting, by counting the elapsed time from the execution of first data writing or data rewriting, the data rewriting may be executed at the time of consumable supply exchange just before the expiration of warranty period of data retention. Operation of controller 20 in this case will be described referring to the flow chart of FIG. 5. In the description below, controller 20 is assumed to count the elapsed time from the data writing to nonvolatile memory 22 or the elapsed time from the previous data rewriting (elapsed days after the rewriting).

Firstly similar to the flow chart of FIG. 3, controller 20 determines if exchange of consumable supply is necessary by monitoring the status of engine 33 (S201). In cases where the exchange of consumable supply is determined to be necessary, controller 20 allows operation panel section of engine 30 to display a screen urging the user to exchange the consumable supply (S202). And controller 20 monitors the operation for exchanging the consumable supply (for example, operation of opening the cover of engine 30) (S203).

When detecting the operation, controller 20 determines whether the elapsed time from the first data writing or the previous data rewriting exceeds the prescribed period calculated based on the warranty period of data retention (S204). For example, in cases where the warranty period of data retention is 3 years (1095 days), said prescribed period may be set as the period (for example 900 days) obtained by subtracting a margin period from the warranty period of data retention.

In cases where the elapsed time from the first data writing or the previous data rewriting has exceeded the prescribed period, controller 20 allows operation panel section of engine 30 to display a screen for notifying the user that the data rewriting of nonvolatile memory 22 is under execution (S205), executes the data rewriting of nonvolatile memory (S206), and when completing the data rewriting, cancels the display, displayed at S205, of under rewriting the data of nonvolatile memory on the operation panel of engine 30 (S207), and by resetting the counter of elapsed days after writing (S208), terminates a series of the process.

As described above, by executing the data rewriting of nonvolatile memory 22 at the first exchange time of consumable supply after elapsing the prescribed period calculated based on the warranty period of data retention, frequent rewriting can be suppressed and the data rewriting can be effectively performed.

In the above flow, since determined is whether the elapsed period after the first writing or the previous rewriting exceeds the prescribed period, for example incases where the exchanging time is delayed due to decrease of toner consumption or in cases where intervals of consumable supply exchanges varies, the case may be possible where the warranty period of data retention has already passed over at the time of exchanging the consumable.

So, in order to solve the above problem, the control of data rewriting is possible such that by calculating the exchange time of consumable supply just before expiration of the warranty period of data retention, based on the consumable exchange time and the warranty period of data retention, the data rewriting is executed at the calculated exchange time of consumable supply. The operation of controller 20 in this case will be described by referring to the flow chart of FIG. 6.

Firstly, controller 20 obtains the exchange period of the consumable supply and the warranty period of data retention in nonvolatile memory 22, and calculates the time of consumable exchange just before expiration of the warranty period of data retention (S301). For example, in the case where the exchange period of the consumable supply is 100 days and the warranty period of data retention is 3 years (1095 days), controller 20 calculates 1ooth day of the 10th exchange time as the consumable supply exchange time for executing the data rewriting.

Similarly to the flow chart of FIG. 3, controller 20 determines if exchange of consumable supply is necessary by monitoring the status of engine 33 (S302). In cases where the exchange of consumable supply is determined to be necessary, controller 20 allows operation panel section of engine 30 to display a screen urging the user to exchange the consumable supply (S303).

Then, if controller 20 determines the present day and time as the calculated exchange time of consumable supply and also detects the operation for exchanging the consumable supply (S304; Yes), controller 20 allows operation panel section of engine 30 to display a screen for notifying the user that the data rewriting of nonvolatile memory 22 is under execution (S305), executes the data rewriting of nonvolatile memory (S306), and when completing the data rewriting, cancels the display, displayed at S305, of under rewriting the data of nonvolatile memory on the operation panel of engine 30 (S307).

As described above, by previously calculating the exchange time of consumable supply just before reaching to the warranty period of data retention, the problem that the warranty period of data retention has already passed over at the time of exchanging the consumable is prevented and effective data rewriting can be executed.

In the above configuration, controller 20 executes the data rewriting of nonvolatile memory 22 when detecting the exchange operation of consumable supply. However, in cases where nonvolatile memory 22 stores a user specified font, the user may execute the data rewriting of nonvolatile memory 22 by operating the operation panel section by oneself. The operation of this case will be described referring to the screen transition examples of on operation panel section in FIG. 7.

When engine 30 is in standby status, the screen shown in FIG. 7(a) is displayed on the operation panel section. In this status, when “MENU” key is pressed, a “MENU” screen shown in FIG. 7(b) is displayed, and when the cursor is moved to select “QUALITY MENU” on this menu screen, a “QUALITY MENU” screen shown in FIG. 7(c) is displayed.

In this quality menu screen, in addition to items regarding quality such as “GRADATION CORRECTION” and “COLOR SEPARATION”, the item of “REWRITING OF NONVOLATILE MEMORY” is provided, and when the cursor is moved to select this item, “REWRITING OF NONVOLATILE MEMORY” screen as shown in FIG. 7(d) is displayed.

Then, when the cursor is moved to select “USER AREA” on this nonvolatile memory rewriting screen screen, a “REWRITING OF USER AREA” screen shown in FIG. 7(e) is displayed, and when the cursor is moved to select a desired font (xxx FONT, in this case), “REWRITING OF xxx FONT” screen as shown in FIG. 7(f) is displayed.

When the cursor is moved to select “EXECUTION” on this screen, rewriting of the desired font is executed, and a “CAUTION” screen as shown in FIG. 7(g) is displayed. Conventionally, only the rewriting of font is executed on nonvolatile memory at this time, however, in the present embodiment rewriting of all data on nonvolatile memory is executed at the time of rewriting the font, since when the user instructs the rewriting of data on nonvolatile memory 22, printing process is not considered to be executed.

In this way, by executing the rewriting of all data when the user rewrites a part of data on nonvolatile memory 22, effective data writing can be performed without exerting influence to the printing process.

The present invention is not restricted to the above described embodiment, but its configuration or control can be changeable insofar as the data rewriting of nonvolatile memory 22 can be executed without impeding primary process of the apparatus such as the printing process.

For example, in a multifunctional printing apparatus, there are cases where the apparatus moves to a power saving mode without power-off after the elapse of certain time from finishing the printing process. In these cases, it is possible to execute the data rewriting at a prescribed timing before moving to the power saving mode or at a timing of first moving to the power saving mode with consideration of margin, before expiration of warranty period for data retention of nonvolatile memory 22.

Further, in usual usage time of the printing apparatus, for example 8:00AM-8:00PM, a print instruction may be conducted immediately after moving to the power saving mode, therefore, it is possible to execute the data rewriting in midnight time zone, for example at 0:00 AM, when only a data receiving function is specified.

The present invention is usable in a control apparatus for controlling an apparatus provided with a consumable supply, and in a method of controlling data rewriting on a nonvolatile memory of the apparatus.

What is claimed is:

1. An image processing apparatus for executing an image processing of print data and instructing a printing to a printing apparatus having a consumable supply, comprising:
a control section which is configured to monitor an exchange operation of the consumable supply and to execute a data rewriting of a nonvolatile memory by using a volatile memory to be used for the image processing.

2. The image processing apparatus of claim 1, wherein the control section executes the data rewriting at a first exchange time of the consumable supply after reaching a time having been set based on a warranty period for data retention of the nonvolatile memory.

3. The image processing apparatus of claim 1, wherein the control section calculates a time for exchanging the consumable supply just before expiration of a warranty period of data retention, based on a consumable exchange time interval and the warranty period of data retention, and executes the data rewriting at the calculated time.

4. The image processing apparatus of claim 1, wherein the control section determines data to be rewritten, in accordance with a time period required for exchanging the consumable supply.

5. The image processing apparatus of claim 2, wherein the control section determines data to be rewritten, in accordance with a time period required for exchanging the consumable supply.

6. The image processing apparatus of claim 3, wherein the control section determines data to be rewritten, in accordance with a time period required for exchanging the consumable supply.

7. A control method of data writing in a printing system comprising a printing apparatus provided with a consumable supply, and an image processing apparatus for executing an image processing of print data and instructing a printing to the printing apparatus, the control method of data writing for the image processing apparatus comprising:
a first step of monitoring an exchange operation of the consumable supply of the printing apparatus; and
a second step of executing a data rewriting of a nonvolatile memory by using a volatile memory to be used for the image processing.

8. The control method of data writing of claim 7, wherein in the second step, the image processing apparatus executes the data rewriting at a first exchange time of the consumable supply after reaching a time having been set based on a warranty period for data retention of the nonvolatile memory.

9. The control method of data writing of claim 7, wherein in the second step, the image processing apparatus calculates a time for exchanging the consumable supply just before expiration of a warranty period of data retention of the nonvolatile memory, based on a consumable exchange time interval and the warranty period of data retention, and executes the data rewriting at the calculated time.

10. The control method of data writing of claim 7, wherein in the second step, the image processing apparatus determines data to be rewritten, in accordance with a time period required for exchanging the consumable supply.

11. The control method of data writing of claim 8, wherein in the second step, the image processing apparatus determines data to be rewritten, in accordance with a time period required for exchanging the consumable supply.

12. The control method of data writing of claim 9, wherein in the second step, the image processing apparatus determines data to be rewritten, in accordance with a time period required for exchanging the consumable supply.
